(19) United States
(12) Patent Application Publication
(10) Pub. No.: US 2021/0111880 A1
(43) Pub. Date: Apr. 15, 2021

(54) ACCESS CONTROL METHODS, ACCESS CONTROL DEVICES, AND COMPUTER READABLE MEDIA

(71) Applicant: AGENCY FOR SCIENCE, TECHNOLOGY AND RESEARCH, Singapore (SG)

(72) Inventors: Shuqin REN, Singapore (SG); Hong Meng Benjamin TAN, Singapore (SG); Khin Mi Mi AUNG, Singapore (SG)

(21) Appl. No.: 15/999,422

(22) PCT Filed: Feb. 15, 2017
(86) PCT No.: PCT/SG2017/050064

§ 371 Date: Aug. 17, 2018

(30) Foreign Application Priority Data
Feb. 18, 2016 (SG) 10201601212S

(51) Int. Cl. H04L 9/08; H04L 9/06; H04L 9/30

(52) U.S. Cl. CPC H04L 9/0833; H04L 9/0894; H04L 9/3033; H04L 9/0643; H04L 9/0825

(57) ABSTRACT

An access control method, which may be applied in a cloud environment, is provided in various embodiments. The access control method includes: receiving from a user a request for access to a resource; determining a group access key related to the resource; determining a user key of the user; determining whether the group key is an integer multiple of the user key; and granting the user access to the resource if it is determined that the group access key is an integer multiple of the user key.

### PRIORITY CLAIM

The present application claims priority to Singapore patent application 10201601212S.

### TECHNICAL FIELD

The following discloses access control methods, access control devices, and computer readable media.

### BACKGROUND

In a cloud environment, files and directories exist as objects hosted by a third party such as a cloud provider, and a service provider can adopt a mechanism commonly used in file system to carry out access control. However, enterprise users may want to user their own access control mechanism. Although some providers allow federated access to integrate the other party's access control solutions, there is no secure group access control solution applicable to cloud environments such that access of resources can be controlled from a cloud infrastructure without disclosing sensitive or private information.

Thus, there is a want for an enhanced group access control method.

### SUMMARY OF INVENTION

According to various embodiments, an access control method may be provided. The access control method may include: receiving from a user a request for access to a resource; determining a group access key related to the resource; determining a user key of the user; determining whether the group access key is an integer multiple of the user key; and granting the user access to the resource if it is determined that the group access key is an integer multiple of the user key.

According to various embodiments, the sum of the group access key and a hash value may be stored.

According to various embodiments, the access control method may further include: authenticating the user.

According to various embodiments, authenticating the user may include: determining a public key related to the user, wherein the public key is based on a product of a first private key of the user and a second private key of the user; determining whether the user is in possession of the first private key; and granting the user authentication if it is determined that the user is in possession of the first private key.

According to various embodiments, determining whether the user is in possession of the first private key may include: providing the user with a residual of a square of a pre-determined number with respect to the public key; receiving a number from the user in response to providing the user with the residual of the square of the pre-determined number with respect to the public key; determining whether a residual of a square of the received number with respect to the public key is identical to the residual of a square of the pre-determined number with respect to the public key; and determining that the user is in possession of the first private key if it is determined that the residual of the square of the received number with respect to the public key is identical to the residual of the square of the pre-determined number with respect to the public key.

According to various embodiments, the access control method may administer access to the resource for a group of users, wherein the group of users includes at least one actual member and at least one pseudo member.

According to various embodiments, the access control method may further include removing a pseudo member from the group performed when an actual member is added to the group.

According to various embodiments, the access control method may further include multiplying the group access key by a number equal to a user key of the user to be added to the group multiplied by an inverse of a user key of the pseudo member to be removed from the group when the actual member is added to the group.

According to various embodiments, the access control method may further include adding a pseudo member to the group when an actual member is removed from to the group.

According to various embodiments, the access control method may further include multiplying the group access key by a number equal to the inverse of a user key of the user to be removed from the group multiplied by a user key of the pseudo member to be added to the group when the actual member is removed from the group.

According to various embodiments, an access control device may be provided. The access control device may include: a receiver configured to receive from a user a request for access to a resource; an access circuit configured to determine a group access key related to the resource; wherein the access circuit is configured to determine a user key of the user; wherein the access circuit is configured to determine whether the group access key is an integer multiple of the user key; and wherein the access circuit is configured to grant the user access to the resource if it is determined that the group access key is an integer multiple of the user key.

According to various embodiments, the access circuit may be configured to store the sum of the group access key and a hash value.

According to various embodiments, the access circuit may be configured to authenticate the user, wherein authenticating the user may include: determining a public key related to the user, wherein the public key is based on a product of a first private key of the user and a second private key of the user; determining whether the user is in possession of the first private key; and granting the user authentication if it is determined that the user is in possession of the first private key.

According to various embodiments, determining whether the user is in possession of the first private key may include: providing the user with a residual of a square of a pre-determined number with respect to the public key; receiving a number from the user in response to providing the user with the residual of the square of the pre-determined number with respect to the public key; determining whether a residual of a square of the received number with respect to the public key is identical to the residual of a square of the pre-determined number with respect to the public key; and determining that the user is in possession of the first private key if it is determined that the residual of the square of the received number with respect to the public key is identical to the residual of the square of the pre-determined number with respect to the public key.

According to various embodiments, the access circuit may be configured to administer access to the resource for a group of users, wherein the group of users includes at least one actual member and at least one pseudo member.

According to various embodiments, the access circuit may be configured to remove a pseudo member from the group is performed when an actual member is added to the group.

According to various embodiments, the access circuit may be configured to multiply the group access key by a number equal to a user key of the user to be added to the group multiplied by an inverse of a user key of the pseudo member to be removed from the group when the actual member is added to the group.

According to various embodiments, the access circuit may be configured to add a pseudo member to the group is performed when an actual member is removed from to the group.

According to various embodiments, the access circuit may be configured to multiply the group access key by a number equal to the inverse of a user key of the user to be removed from the group multiplied by a user key of the pseudo member to be added to the group when the actual member is removed from the group.

According to various embodiments, a computer readable medium may be provided. The computer readable medium may include instructions which, when executed by a processor, make the processor perform an access control method. The access control method may include: receiving from a user a request for access to a resource; determining a group access key related to the resource; determining a user key of the user; determining whether the group access key is an integer multiple of the user key; and granting the user access to the resource if it is determined that the group access key is an integer multiple of the user key.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1A shows a flow diagram illustrating an access control method according to various embodiments.

FIG. 1B shows an access control device according to various embodiments.

FIG. 2 shows an illustration of various data sets according to various embodiments.

FIG. 3 shows an illustration of data according to various embodiments.

FIG. 4 shows an illustration of oblivious identification according to various embodiments.

FIG. 5 shows an illustration of flexible group access control according to various embodiments.

FIG. 6 shows an illustration of oblivious identification according to various embodiments.

FIG. 7 shows an illustration of secure yet flexible access control according to various embodiments.

FIG. 8 shows an illustration of data sharing on the cloud according to various embodiments.

FIG. 9 shows an illustration of data uploading (for example using a virtual group key manager according to various embodiments) to a cloud according to various embodiments.

FIG. 10 shows an illustration of data sharing (for example using a virtual group key manager according to various embodiments) on a cloud according to various embodiments.

FIG. 11 shows an illustration of member revocation or member revoking (for example using a virtual group key manager according to various embodiments) on a cloud according to various embodiments.

FIG. 12 shows a computer system according to various embodiments.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the preferred embodiments to disclose a method and system which is able to grant access to users which are members in a group.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “determining”, “receiving”, “granting”, “sending”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms presented herein are not inherently related to any particular computer or other apparatus. Various general purpose machines may be used with programs in accordance with the teachings herein. Alternatively, the construction of more specialized apparatus to perform the required method steps may be appropriate.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method. The computer readable medium may be a non-volatile computer readable medium. The computer readable medium may be a volatile computer readable medium. The computer readable medium may be a non-transitory computer readable medium.

According to various embodiments, devices and methods for virtual group access control may be provided. A virtual group may be understood as a group of users (in other words: a group of members). Each user of the group of users may have access to a pre-determined resource, such as data (for example a file or directory) or a service (such as a computational resource or computing service). According to various embodiments, a virtual group access control protocol may be provided in a cloud computing environment. Devices and methods for securely controlling cloud resources may be provided, for example by deploying a proxy on a cloud infrastructure.

Cloud storage may provide users with flexible accessibility to their resources such as files and folders (in other words: directories). Users may access their data anywhere anytime as long as network connection to the cloud, for example internet connection, is available. Users may share their resources with peers and friends easily through cloud services. However, it is the provider's capability to provide access control which lets enterprise worry about data leakage. Cloud providers may enable federated access to allow enterprise users setup a proxy to do third-party access control, which leaves the question of secure deployment of proxy to enterprise user. According to various embodiments, secure deployment of key manager proxy to do access control over the resources on the cloud may be provided.

Access control has been used by file system, existing as a form of utility. Files and directories have permission sets for their owners, the associated groups and all other users for the system. These access control features normally exist as metadata in cleartext and the metadata may be kept in an on-disk structure called an “inode”. Each read or write may be controlled by checking the corresponding permission in inode. It's an efficient and lightweight access control. File data normally are stored in data blocks, existing together with inode in the local file system.

In a cloud environment, files and directories exist as objects hosted by a third party such as a cloud provider, and a service provider can adopt a mechanism commonly used in file system to carry out access control. However, enterprise users may want to user their own access control mechanism. Although some providers allow federated access to integrate the other party's access control solutions, there is no secure group access control solution applicable to cloud environments such that access of resources can be controlled from a cloud infrastructure without disclosing sensitive or private information.

In the following, access control in a traditional file system will be described.

Most file systems use permissions or access rights to specific users and groups of users. Permissions are managed in three distinct scopes or classes, known as user, group and others. These read permission grants the ability to read a file; the write permission grants the ability to write a file; the execute permission grants the ability to execute a file. An example of symbolic notation of a file permission is as follows:

-rwxr-xr-x: a regular file whose user class has full permissions and whose group and others classes have only the read and execute permissions.

When a user accesses a file, the system checks whether the user is the owner, group user or other user and then grants or denies its access request according to the corresponding permission of the file.

This access control is very simple and efficient for file system by checking the file's metadata (in other words: the inode of the file) which includes the above permission to grant or deny a user's read/write requests. It is applicable for local file system. While in cloud environment, users such as for example enterprises prefer their own and customized access control, which are invisible to the file system at cloud. According to various embodiments, a privacy preserved metadata is provided to do access control at federated access proxy. The metadata is used to do access check without knowing or revealing the user's identity.

In commonly used systems, access control is bounded by an object, and stored as attributes with the object for federated access. In commonly used systems, user-password/PIN (personal identification number) identification may be provided, wherein secrets are given (in other words: revealed or released), and secrets may be visible to the verification party. In commonly used systems, access control may be provided, wherein permission attributes are used to decide user access or group access, and the verification party must be trusted.

In the following, Amazon Identity Federation will be described.

AWS (Amazon Web Services) Identity and Access Management (IAM) supports identity federation for delegated access to the AWS Management Console. Through this management console, end users can access files stored on Amazon cloud storage (S3). With identity federation, external identities (for example federated users) are granted secure access to resources in your AWS account without having to create IAM users. These external identities can come from your corporate identity provider (such as Microsoft Active Directory or from the AWS Directory Service) or from a web identity provider, such as Amazon Cognito, Login with Amazon, Facebook, Google or any OpenID Connect (OIDC) compatible provider.

This federation solution requires a small client application running on enterprise staff's work station. The application talks to a “federation proxy”, first it log into the external identity system, e.g., corporate directory system; then the proxy requests temporary security credentials for each user from AWS service. These credentials are associated with a set of permissions and expire period. These credentials get passed back to the client application, providing secure and direct access to the S3 bucket.

However, such an external identity system does not suit to deploy on cloud environment if these above external identity providers cannot provide privacy preserved identity.

According to various embodiments, an external identity proxy with privacy protection is provided, which may be securely deployed on a cloud environment. According to various embodiments, secure group management for object access control may be provided, where data is secured against a proxy sitting on the cloud, against the service provider, and against individual users.

According to various embodiments, secrets are used for checking instead of being released, and verification may be performed without knowing the secrets. According to various embodiments, verification evaluation may be used to decide access, and verification may be outsourced.

According to various embodiments, secure access control over cloud resources (e.g., objects) may be provided, and leaking information to third parties is avoided. With a virtual group key manager (VGKM) according to various embodiments as a proxy sitting on cloud, the proxy may securely verify the user's identity by oblivious identification for users. The proxy may efficiently control the access on the resources over the cloud. Oblivious identification may allow the proxy to identify legitimate users without knowing a user's secret and make it deployable on a public cloud. Efficient access control allows enterprise to do their own on-demand membership checking, member recruiting (or member adding) and revocating (or revoking) by their own policies instead of provider's mechanisms.

Various embodiments allow secure membership checking and flexible access control on resources over cloud. Various embodiments are independent on a specific service, and may be applicable to any cloud services.

According to various embodiments, oblivious identification may be provided, wherein it is determined whether a user is who he claims to be, without revealing secrets. Oblivious identification according to various embodiments may be applicable for authentication even on an untrusted party. According to various embodiments, flexible group authentication/access control may be provided, which is transparent to existing members when new members are joining or members are leaving the group. Objects may be bound by access control, and verification may be performed with object attributes.

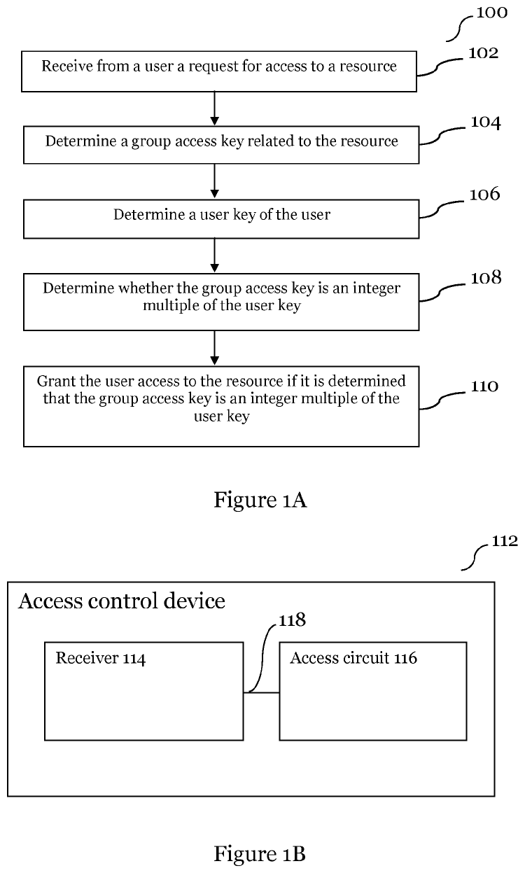

FIG. 1A shows a flow diagram 100 illustrating an access control method according to various embodiments. In 102, a request for access to a resource may be received from a user. In 104, a group access key related to the resource may be determined. In 106, a user key of the user may be determined. In 108, it may be determined whether the group access key is an integer multiple of the user key. In 110, the user may be granted access to the resource if it is determined that the group access key is an integer multiple of the user key.

According to various embodiments, the sum of the group access key and a hash value may be stored.

According to various embodiments, the access control method may further include: authenticating the user.

According to various embodiments, authenticating the user may include: determining a public key related to the user, wherein the public key is based on a product of a first private key of the user and a second private key of the user; determining whether the user is in possession of the first private key; and granting the user authentication if it is determined that the user is in possession of the first private key. It will be understood that it is enough to provide proof of being in possession of the first private key to authenticate as the user, because the second private key may be derived from the public key and the first private key (in other words: if someone knows the public key and the first private key, it is easy for him to determine the second private key, and as such, it is not necessary to require proof of being in possession of the first private key and the second private key one of the first private key or the second private key is enough).

According to various embodiments, determining whether the user is in possession of the first private key may include: providing the user with a residual of a square of a pre-determined number with respect to the public key; receiving a number from the user in response to providing the user with the residual of the square of the pre-determined number with respect to the public key; determining whether a residual of a square of the received number with respect to the public key is identical to the residual of a square of the pre-determined number with respect to the public key; and determining that the user is in possession of the first private key if it is determined that the residual of the square of the received number with respect to the public key is identical to the residual of the square of the pre-determined number with respect to the public key.

According to various embodiments, the access control method may administer access to the resource for a group of users, wherein the group of users includes at least one actual member and at least one pseudo member.

According to various embodiments, the access control method may further include removing a pseudo member from the group performed when an actual member is added to the group.

According to various embodiments, the access control method may further include multiplying the group access key by a number equal to a user key of the user to be added to the group multiplied by an inverse of a user key of the pseudo member to be removed from the group when the actual member is added to the group.

According to various embodiments, the access control method may further include adding a pseudo member to the group when an actual member is removed from to the group.

According to various embodiments, the access control method may further include multiplying the group access key by a number equal to the inverse of a user key of the user to be removed from the group multiplied by a user key of the pseudo member to be added to the group when the actual member is removed from the group.

FIG. 1B shows an access control device 112 according to various embodiments. The access control device 112 may include: a receiver 114 configured to receive from a user a request for access to a resource. The access control device 112 may further include an access circuit 116 configured to determine a group access key related to the resource. The access circuit 116 may further be configured to determine a user key of the user. The access circuit 116 may further be configured to determine whether the group access key is an integer multiple of the user key. The access circuit 116 may further be configured to grant the user access to the resource if it is determined that the group access key is an integer multiple of the user key. The receiver 114 and the access circuit 116 may be coupled, like indicated by line 118, for example electrically coupled and/or optically coupled and/or mechanically coupled.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

According to various embodiments, the access circuit 116 may be configured to store the sum of the group access key and a hash value.

According to various embodiments, the access circuit 116 may be configured to authenticate the user, wherein authenticating the user may include: determining a public key related to the user, wherein the public key is based on a product of a first private key of the user and a second private key of the first user; determining whether the user is in possession of the first private key; and granting the user authentication if it is determined that the user is in possession of the first private key.

According to various embodiments, determining whether the user is in possession of the first private key may include: providing the user with a residual of a square of a pre-determined number with respect to the public key; receiving a number from the user in response to providing the user with the residual of the square of the pre-determined number with respect to the public key; determining whether a residual of a square of the received number with respect to the public key is identical to the residual of a square of the pre-determined number with respect to the public key; and determining that the user is in possession of the first private key if it is determined that the residual of the square of the received number with respect to the public key is identical to the residual of the square of the pre-determined number with respect to the public key.

According to various embodiments, the access circuit 116 may be configured to administer access to the resource for a group of users, wherein the group of users includes at least one actual member and at least one pseudo member.

According to various embodiments, the access circuit 116 may be configured to remove a pseudo member from the group is performed when an actual member is added to the group.

According to various embodiments, the access circuit 116 may be configured to multiply the group access key by a number equal to a user key of the user to be added to the group multiplied by an inverse of a user key of the pseudo member to be removed from the group when the actual member is added to the group.

According to various embodiments, the access circuit 116 may be configured to add a pseudo member to the group is performed when an actual member is removed from to the group.

According to various embodiments, the access circuit 116 may be configured to multiply the group access key by a number equal to the inverse of a user key of the user to be removed from the group multiplied by a user key of the pseudo member to be added to the group when the actual member is removed from the group.

According to various embodiments, a computer readable medium may be provided. The computer readable medium may include instructions which, when executed by a processor, make the processor perform an access control method. The access control method may include: receiving from a user a request for access to a resource; determining a group access key related to the resource; determining a user key of the user; determining whether the group access key is an integer multiple of the user key; and granting the user access to the resource if it is determined that the group access key is an integer multiple of the user key.

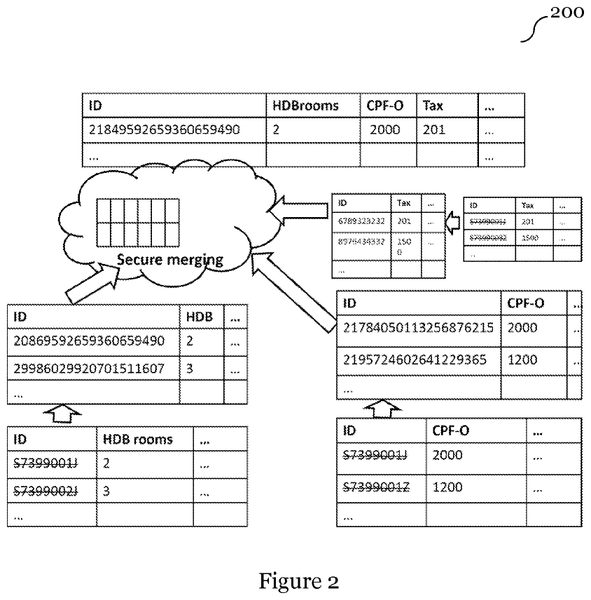

FIG. 2 shows an illustration 200 of various data sets according to various embodiments. FIG. 2 shows the process of transforming the plain information from various agencies/users into encrypted strings which is sent to the cloud/secure merging center and converted into the final table at the top.

According to various embodiments, data related to residents' finance or wealth analysis (for example residents' CPF (Central Provident Fund) spent distribution, residents' housing status, or correlations between these accounts) may be shared without personal privacy leakage.

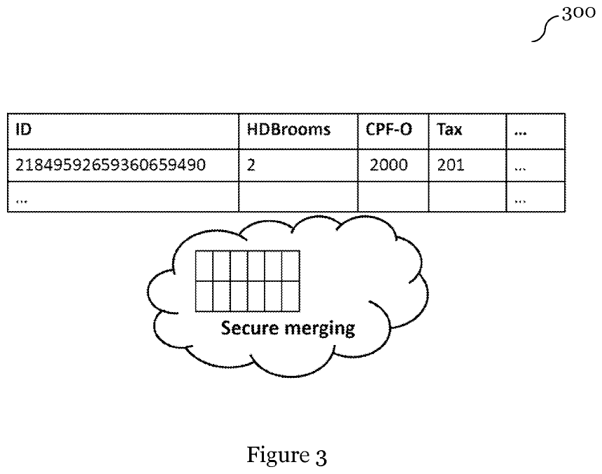

FIG. 3 shows an illustration 300 of such data. According to various embodiments, the question who can access these shared data may be addressed. Secure merging of such data may be provided. FIG. 3 shows the result of the merging at the secure merging center which is a table with encrypted identifier (ID) and various columns of data which are associated with the IDs.

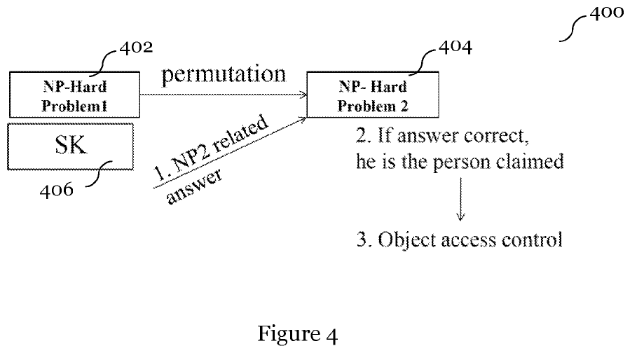

FIG. 4 shows an illustration 400 of oblivious identification according to various embodiments, wherein it may be determined whether a user is who he is claiming to be. According to various embodiments, a zero-knowledge proof of identification may be provided. A first (NP) hard problem (NP1) 402 may be reduced to (or converted into) a second (NP) hard problem NP2, illustrated by 406, so that if NP2 (406) can be solved, this is a proof that NP1 (402) can (or could) be solved (in other words, a secret key 404, which is needed for solving NP1 (402) is known by the user). It will be understood that an NP hard problem is a problem which is non-deterministic polynomial-time hard (in other words, for which a solution may not be found in a time which may be expressed as a (finite) polynomial of the size of the problem).

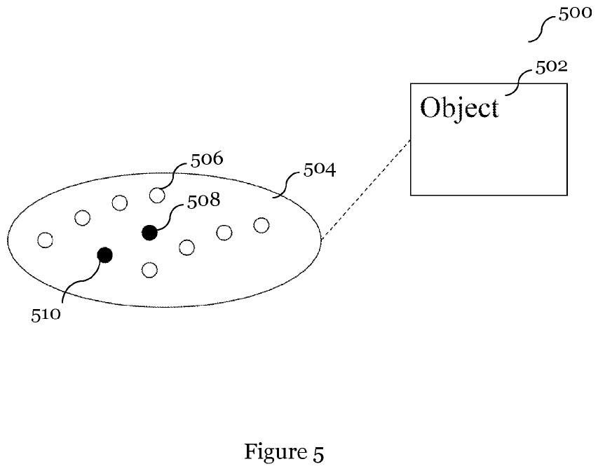

FIG. 5 shows an illustration 500 of flexible group access control according to various embodiments. According to various embodiments, it may be determined whether a user is able (in other words: allowed; in other words: permitted) to access an object 502. Object 502 may be an access control bound object. According to various embodiments, verification may be performed with object attributes. According to various embodiments, oblivious identification and object's access control may be performed. Data of various users, for example illustrated by 506, 508, and 510, is shown.

According to various embodiments, an end user U, may have a secrecy (in other words: secret; in other words: secret key) which may include or may be two big prime numbers (pᵤ₁, pᵤ₂) and the corresponding public key may be N=pᵤ₁pᵤ₂, i.e. the public key may be the product of the two big prime numbers pᵤ₁ and pᵤ₂. If a user claims that he is U, he should be able to show that he knows his secrecy (pᵤ₁, p₂), and his public key is N=pᵤ₁pᵤ₂. If a plurality of users Uᵢ with respective public keys Nᵢ exist, each Nᵢ may be mapped into a big prime member key Pᵢ=fₘₐₚ(Nᵢ).

According to various embodiments, oblivious identification may be understood as follows. A user may prove that he is U without showing his secrecy (pᵤ₁, pᵤ₂) by taking a challenge to show his capability. According to various embodiments, if the end user can show he can find square roots for random quadratic residues in Z_{N}* (which may be understood as being the space of numbers modulo N), it means he knows (pᵤ₁, pᵤ₂).

According to various embodiments, a resource (e.g. file, directory) may be referred to as R. Given a resource R, its group access key is denoted as K_{R} which corresponds to the permission of accessing or using this resource R and the value K_{R} may be used to evaluate who has the corresponding permission or who has membership. A resource R may have a set of secure codes {Rᵥ}={Rᵥ₁, Rᵥ₂, Rᵥ₃, . . . }.

According to various embodiments, a group g may have n_{g} members {m₁, m₂, m₃, . . . , m_{ng}} who can access resource R. Each member mⱼ may have a corresponding prime number Pⱼ for access authentication. The group may also have nₚₜ pseudo members {mₚ₁, mₚ₂, mₚ₃, . . . , mₚₜ}, so that n_{g}+nₚₜ=s_{g}, and each pseudo member mₚₖ may have a corresponding prime number Pₚₖ.

According to various embodiments, oblivious identification may be based on the principle of the hardness of finding square roots for quadratic residues. If N=pq is the product of two distinct odd primes, then finding square roots for random quadratic residues in Z_{N}* is as hard as factorizing N. In other words, a person can find square roots for random quadratic residues in Z_{N}* iff (if and only if) he can factorize N, which is equivalent to him knowing the secret (in other words, the two distinct prime number p, which may be referred to as pᵤ₁, and q, which may be referred to as pᵤ₂). According to various embodiments, oblivious identification may refer to identification wherein the verification party can check the person's identity without knowing the person's secret.

In the following, oblivious identification for secure verification on a cloud according to various embodiments will be described.

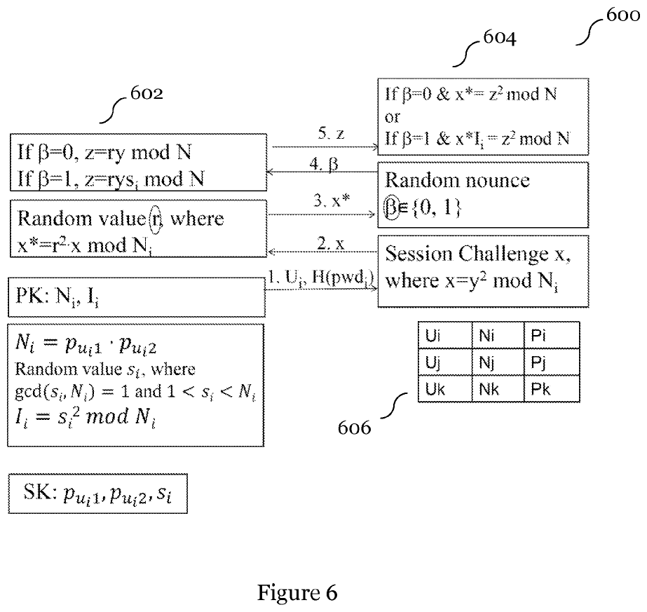

According to various embodiments, the secret related prime factoring problem (in other words, the problem of finding prime numbers which are a factor of a large number, and in the case of authentication the problem of providing pᵤ₁ and/or pᵤ₂ in response to being provided with the number N, wherein N=pᵤ₁ pᵤ₂) may be converted into the problem of providing square roots for random quadratic residues (in other words, the problem of finding ry mod Nᵢ when provided with r²y² mod Nᵢ); in other words, the square root problem may be used instead of the factoring problem. Solving square roots for random quadratic residues may prove the ability to factorize without the necessity to reveal the secrets related (in other words: the secret prime numbers). Thus the identity verification can be done without revealing the private information of users, and can for example be carried out on a cloud environment. Users can verify that they are holders to the secret information that is linked to the public identifier Nᵢ. The oblivious identification workflow can be as shown in illustration 600 of FIG. 6. The left side 602 of FIG. 6 may be related to the application running on a client (for example at an enterprise user), and the right part 604 may be related to a module on the federated proxy which sits on cloud environment. Each enterprise user Uᵢ has a secret key SKᵢ={pu₁ᵢ, pu₂ᵢ, sᵢ} and a public key PK={Nᵢ, Iᵢ}, wherein pu₁ᵢ and pu₂ᵢ are prime numbers, and Nᵢ=pu₁ᵢpu₂ᵢ. The public key may be is shared with the proxy. The circles around r and β in FIG. 6 are to indicate that the transcript of the protocol is randomized and thus is not susceptible to replay attacks.

A user may log into the identity system according to various embodiments by giving his username Uᵢ and password pwdᵢ. The username and password may be verified as in a conventional authentication, like shown as step 1 in FIG. 6. If verified, the proxy may give a dynamic session challenge x to the user, where x=y² mod Nᵢ, as step 2 in FIG. 6. The user may generate another random number r and send back of r²x mod Nᵢ to server, wherein r²x mod Nᵢ may be denoted as x*. The server may randomly choose a nounce from {0,1} and challenge the client. The client may give the corresponding solution accordingly and send back to server, as step 5 in FIG. 6. It can be seen that the client sends either ry mod Nᵢ or the masked number rsᵢy mod Nᵢ. In both cases, the user proves that he is able to determine the residual square y of y², and that thus he is in possession of the prime numbers p_{u1,i} and p_{u2,i}. The server doesn't know sᵢ, but can verify whether the user indeed is Uᵢ as he has claimed.

The protocol as shown in FIG. 6 is used to authenticate the identity of the client. According to various embodiments, with the steps as described above and shown in FIG. 6, the client has to possess pᵤ₁ and pᵤ₂ to derive y from x. It is to be noted that obtaining y through a lucky guess can occur with probability 1/[(pᵤ₁−1)(pᵤ₂−1)]. Repeating the protocol several times and requiring that all of them verify successfully may reduce the chances of false authentication by lucky guesses.

It is to be noted that as used in the description of the process, the server may be understood as the federated proxy and the client may be understood as the application running on enterprise staff's work station.

The identification according to various embodiments is followed by access control according to various embodiments. To provide group access control, each identity is mapped to a prime number as (Nᵢ, Pᵢ), where Pᵢ is used as a member key for group management. A table 606 is maintained at the federated proxy with {Uᵢ, Nᵢ, Pᵢ}, as shown in FIG. 6. In the following, access control details will be described.

According to various embodiments, a (shared) group access key for a resource Rₛᵥ (which may be an i-th resource) may be defined as

K_{R}_{ₛᵥ}=ΠRᵥₙ·ΠPⱼ where j=1˜sg (1)

wherein each Pⱼ may map to an N (which may correspond to an identification of a user, like illustrated by table 606 in FIG. 6).

In other words, each file is associated with a resource identifier Rsᵥ and a public value, ΠRsᵥ·ΠPⱼ+H(kₕ,Rsᵥ) (wherein Rsᵥ are random masks, and Pⱼ is associated to Nⱼ, which is a the public parameter for user j). The group that is allowed to access the file is the set of users q with P_{q} in the public value. Verifying that user q has access rights requires that the virtual group key manager processes the public value by removing H(kₕ, Rsᵥ) and then checking the remaining term ΠRsᵥ·ΠPⱼ is divisible by P_{q}.

An example of equation (1) may be as follows: K_{R}_{_{S1}}=(R₁₁·R₁₂·R₁₃·R₁₄·R₁₅)·ΠPⱼ

As formulated in equation (1), the group access key K_{R}_{ₛᵥ} for resource Rₛᵥ is defined as the multiplication of its resource secure codes followed by the other multiplication of the group members' primes.

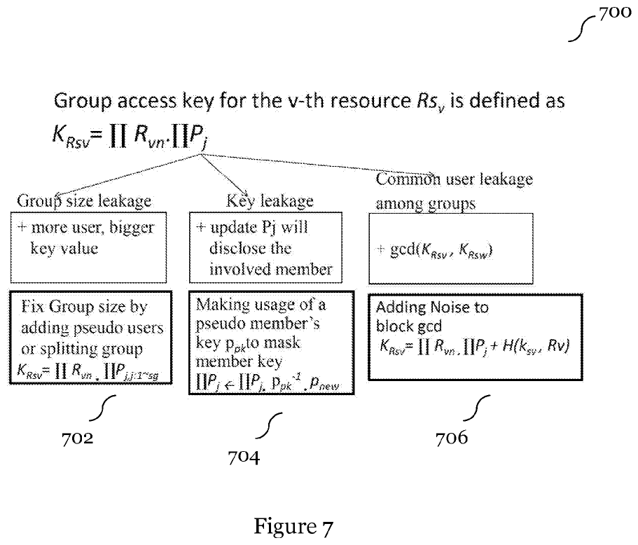

Regarding the multiplication, it is to be noted that the group members do not only include the group's real group members but also the pseudo members, with allows for a fixed group size s_{g}, even if member are joining the group or leaving the group. Thus, the group size and key size are hidden, like illustrated in the left column 702 of illustration 700 of FIG. 7.

However, such kinds of (access) control keys are stored on a cloud storage, where the cloud provider can analyze common primes among different resources with a greatest common divisor (gcd), as shown in illustration 700 of FIG. 7. According to various embodiments, to avoid that the cloud provider can perform such an analysis, noise may be added before sending it to cloud by adding a hash value H(kₕ, Rᵥ), like illustrated by the right column 706 of FIG. 7, and as shown in equation (2) below, wherein kₕ is a key for the hash function. kₕ may be used to keep the exact hash function private and reduce the likelihood of breaking the scheme. Only with kₕ can the correct values H(kₕ, Rᵥ) be obtained to remove the blinding masks.

K_{R}_{ₛᵥ}=ΠRᵥₙ·ΠPⱼ+H(kₕ,Rᵥ)

for example K_{R}_{_{S1}}=(R₁₁·R₁₂·R₁₃·R₁₄·R₁₅)·ΠPⱼ+H(kₕ,R₁) (2)

This hash value can effectively hide the common users, at least the number of common users hacked using gcd, by adding a random number. This protection is against the other tenants and service providers from the cloud, which is managed by the VGKM, and does not bother the key manager at the trusted side (in other words: the key manager need not be involved in the protocol and the unmasking can be “outsourced” or delegated to a virtual group key manager) Adding the hash may require the proxy to maintain the hash key and may add computational overhead to compute this function before/after sending/getting metadata from cloud storage.

According to various embodiments, when a new member mᵤ joins into the shared group, the group key may be securely computed (in other words: updated) as shown in equation (3). The member key of mᵤ may be masked by one of the pseudo member's member key reversed (Pₚⱼ⁻¹).

K_{R}_{ₛᵥ}=(K_{R}_{ₛᵥ}−H(kₕ,Rᵥ))·Pᵤ·Pₚⱼ⁻¹+H(kₕ,Rᵥ) (3)

By this method of update, the member key may be protected and the key size may be maintained regardless of resource key, while no action is required from the other users.

According to various embodiments, when a member mᵤ leaves the shared group, the group key may be securely computed (in other words: updated) as shown in equation (4). The member key of mᵥ is masked by a new pseudo member key Pₚᵤ, by which the group access key is multiplied, so that the group size is still s_{g}.

K_{R}_{ₛᵥ}=(K_{R}_{ₛᵥ}−H(kₕ,Rᵥ))·Pᵥ⁻¹·Pₚᵤ+H(kₕ,Rᵥ) (4)

Masking as described above according to various embodiments may prevent key leakage, like illustrated by middle column 704 of the illustration 700 of FIG. 7.

It will be understood that the actual group access key used does not include the hash term H(kₕ, R). As such, when a member mᵤ joins the group, the key is updated to be (K_{R}_{ₛᵥ}−H(kₕ, R))·Pᵤ·Pₚₖ⁻¹, whereas the value stored on the cloud is updated to K_{R}_{ₛᵥ}=(K_{R}_{ₛᵥ}−H(kₕ, R))·Pᵤ·Pₚₖ⁻¹+H(kₕ, Rᵥ), and no action from other users is required. Likewise, when a member m leaves the shared group, the key is updated to be (K_{R}_{ₛᵥ}−H(kₕ, R))·Pₚₖ·Pᵥ⁻¹, whereas the value stored on the cloud is updated to K_{R}_{ₛᵥ}=(K_{R}_{ₛᵥ}−H(kₕ, R))·Pₚₖ·Pᵥ⁻¹+H(kₕ, Rᵥ), and no action from other users is required.

By this method of update, the revoked member key is protected, the resource key is protected and the key size is maintained. The protection of common group users is the same as described in relation to a new member joining. Likewise, no action is required from other users.

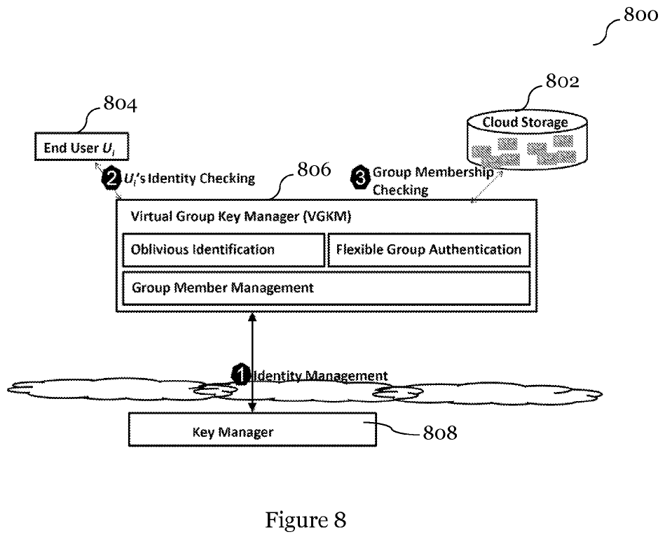

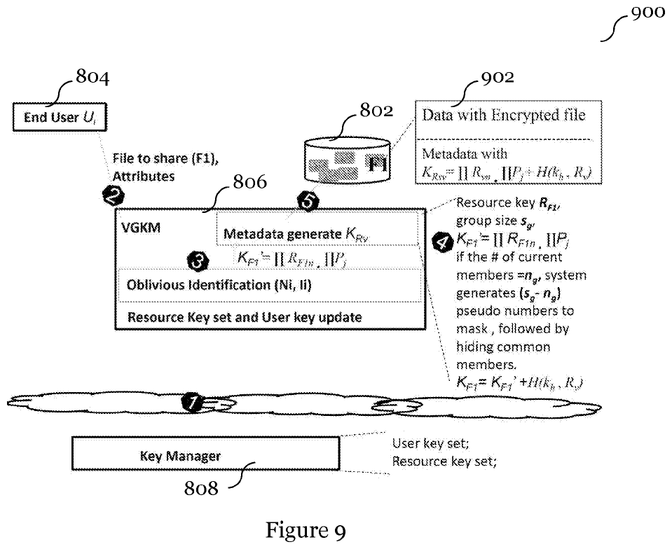

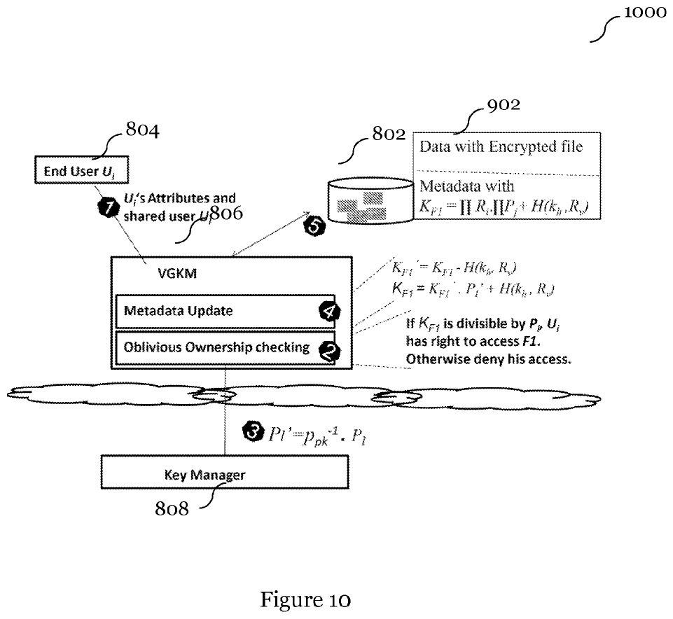

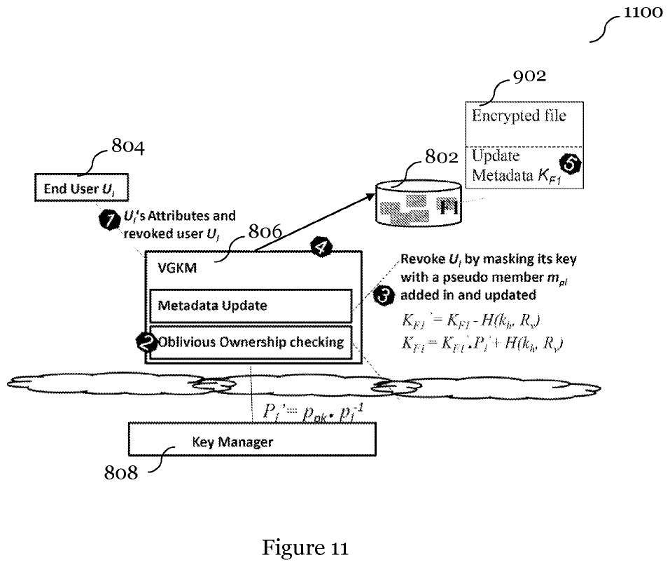

In the following, workflow in operation according to various embodiments will be described. It will be understood that steps as described in relation to the methods shown in FIG. 8, FIG. 9, FIG. 10, and FIG. 11 are illustrated as hexagons with the numbers (e.g. 1, 2, 3, . . . ) inside, and these steps may be different or identical amongst FIG. 8, FIG. 9, FIG. 10, and FIG. 11. For example, step 1 illustrated in FIG. 8 may be different from step 1 illustrated in FIG. 9, like will be described in the following. For example, step 2 illustrated in FIG. 10 may be identical or similar to step 2 illustrated in FIG. 11. Details on each of the steps will be provided in the following.

FIG. 8 shows an illustration 800 of data sharing on the cloud according to various embodiments. A cloud storage 802 may store data (for example a file F1 to be shared in a group of users). An end user Uᵢ 804 may be a member of the group and may request access to the file F1. A virtual group key manager 806 (VGKM; in other words: an access control device according to various embodiments) may perform oblivious identification, flexible group authentication, and group member management. The virtual group key manager 806 may make use of a key manager 808 for identity management (illustrated as step 1 in FIG. 8). It will be understood that the key manager 808 may be part of the virtual group key manager 806 or may be provided separate from the virtual group key manager 806. The virtual group key manager 806 may securely manage access control for the cloud resource (for example files stored on the cloud storage 802, or for any other kind of resources, for example for a computational service provided (not shown in FIG. 8)). The virtual group key manager 806 may provide flexibility, as no other members than the user joining the group or leaving the group are affected when a user joins or leaves the group. Step 2 shown in FIG. 8 may include checking and verifying the user Uᵢ's identity (in other words: authentication of user Uᵢ). Step 3 shown in FIG. 8 may include group member checking (in other words, checking, whether user Uᵢ is a member of the group which has access rights to the file on the cloud storage).

FIG. 9 shows an illustration 900 of data uploading to a cloud (for example for sharing data) according to various embodiments. The virtual group key manager (VGKM) 806 may securely manage access control for the cloud resource 802. No interaction with the trusted key manager 808 may be necessary. Each resource may have the same group size (by making use of pseudo members) to prevent leakage. Each group key may have the same length (by making use of pseudo members) to prevent prediction.

When an object is first send to cloud, the object and its metadata may be put into the cloud. Before uploading to the cloud, the object's metadata may define who has what right to access this object. According to various embodiments, a big number, which is the resource control key multiplied with the multiplication of all group member's prime number keys, may be used to define this object's access control information. This computation may be carried out on the trusted key manager, and the result may be forwarded to the VGKM (as step 1 shown in illustration 900 of FIG. 9, wherein the user key may be set and the resource key may be set). The VGKM may further do metadata masking, and may upload the masked metadata and data to cloud. In step 2 illustrated in FIG. 9, the user may provide a file (for example referred to as F1) to share and attributes of the file (for example which group may have access to the file). In step 3 illustrated in FIG. 9, oblivious identification of user Uᵢ may be carried out using Nᵢ and Iᵢ as described above. Metadata may be generated, including a resource key R_{F}_{₁} for the resource F₁ as described above. The group size may be kept at s_{g} by use of pseudo members, and a hash value H(kₕ, Rᵥ) may be added to avoid that members common to the same groups may determine secret keys. In step 5 as illustrated in FIG. 5, the metadata and the file F₁(901) are stored on the cloud.

FIG. 10 shows an illustration 1000 of secure data sharing within a group according to various embodiments will be described. In step 1 as illustrated in FIG. 10, user Uₗ 804 may transmit his attributes and information about the new user Uₗ to the VGKM 806. The VGKM may perform oblivious ownership checking, like indicated by step 2 in FIG. 10. If an object is to be shared with a new user Uₗ, the metadata information may be updated, and two steps may be desired: 1) masking new user's key by multiply a masked random number (random choosing from the pseudo members' primes and getting its reverse or inverse) to the user's prime number, like indicated by step 3 in FIG. 10; 2) multiplying the existing group control key with this new masked key. With these two steps, the new group control key has the new member's prime number as a divisor, and thus the membership of user Uᵢ to the group can be checked. The above two steps may occur at the trusted server, like indicated by step 4 of FIG. 10, and the results may be forwarded to the VGKM, like indicated by step 5 of FIG. 10. The VGKM may do further masking, may update the metadata and may then upload and store the metadata on the cloud. While the other group users are transparent to this change, they do not need to take any actions.

FIG. 11 shows an illustration 1100 of secure member revocation according to various embodiments. In step 1 as illustrated in FIG. 11, user Uᵢ 804 may transmit his attributes and information about the to be revoked user Uₗ to the VGKM 806. The VGKM may perform oblivious ownership checking, like indicated by step 2 in FIG. 11. When a user Uₗ leaves (or left) the group (in other words, when a user Uₗ is to be revoked), his membership has to be revoked. In order to securely revoke his key, according to various embodiments, the proxy may carry out a secure division on this key. First, the reverse (or inverse) of this user's prime is extracted. Secondly, the reverse is multiplied with a new pseudo random member's prime (this multiplication may also be referred to as masking; like illustrated in step 3 in FIG. 11). The result, as a revocation information, is sent to proxy. Fourth, the proxy may multiply the current group key with the received “revocation key” to complete the member revocation. This process does not leak any group related information, even to the proxy while other group members are transparent to this change. In order to securely store the key to the cloud, the VGKM may do (another) masking by adding a random number (for example the hash value as described above) to the metadata before updating the cloud metadata (like illustrated by step 5 in FIG. 11), as the metadata process of secure sharing. In step 4 in FIG. 11, the new key information is sent to the cloud storage 802.

For performance evaluation, the group access control scheme according to various embodiments may be integrated with dropbox and experiments may be performed to verify the correctness of the scheme and measure its performance overhead and storage capacity added.

The time taken to upload and download files of variable size may be measured to determine the performance overhead incurred by the trusted proxy according to various embodiments. The total data transferring time from access control, data encryption/decryption, deduplication to upload/download with the proxy according to various embodiments may be compared with commonly used Dropbox applications.

Table I shows experimental results of uploading speed analysis.

TABLE I
UPLOADING SPEED ANALYSIS RESULTS

| File Size | With Proxy | Withough Proxy |
|---|---|---|
| 180 Kb pdf | approx. 7 secs | <3 secs |
| 6.5 Mb Audio File | approx 45 secs | <20 secs |
| 40 Mb Video clip | 2 mins | approx. 1-2 mins |
| >230 Mb Zip file | 5 mins | 4 mins |

The experiments which lead to the data shown in Table I have been carried out with Dropbox using its core API (application programming interface). A proxy was setup to use Dropbox storage as dump storage. The overhead observed may be due to metadata update. According to various embodiments, the proxy may be scaled to compensate for the performance loss. As can be seen from Table I, the bigger the size of the file under consideration, the smaller is the (relative) gap (or performance loss).

Download speed results are listed in Table II below. Various embodiments may have slight difference for download performance, with 1-2 seconds for a small file and within a minute for a big file. The reason may be that the access control mechanism according to various embodiments requires a simple mathematical divisions and multiplications. Regarding scalability, multiple proxy nodes may be set to perform access control.

TABLE II
DOWNLOAD SPEED ANALYSIS RESULTS

| File Size | With Proxy | Withough Proxy | |
|---|---|---|---|
| 180 Kb pdf | approx 4 secs | 1-2 | secs |
| 6.5 Mb Audio File | approx 30 secs | <20 | secs |
| 40 Mb Video clip | 2 mins | 1 | mins |
| >230 Mb Zip file | approx 7 mins | 7 | mins |

As shown in Table II, there is less overhead for downloading, and the bigger the size of data is, the smaller is the gap in overhead.

With respect to capacity overhead, since to each file there will be added 64 bytes of capacity to store the metadata, the access control key, the capacity overhead is acceptable.

As described herein, cloud storage may provide flexible resource access and elastic storage capacity, which attracts users, for example enterprise users. However, users may worry about data accessed by other illegitimate users or cloud provider since the data is stored on cloud. If user can control who can access their resources on the cloud without sacrificing cloud's benefit, they would make full usage of cloud storage as their data warehouse.

According to various embodiments, secure access control is provided, for example on resources over storage cloud. According to various embodiments, a customized, for example enterprise customized, access control proxy is provided, for example in a cloud (in other words: the access control proxy is sitting on cloud).

According to various embodiments, oblivious identification is provided. Since the proxy is provided on the cloud, it may be volatile to be compromised. It should not keep sensitive information. Oblivious identification according to various embodiments may provide secure identification checking without knowing and keeping the identity's secret.

According to various embodiments, secure and flexible access control is provided. An efficient and flexible mechanism for users to share resources over cloud is provided. Access control update (when a user is joining the group or a user is leaving the group) will not bother existing users in the group while keeping sensitive control information hidden.

Various embodiments may be practical with little overhead to make the embodiments applicable to enforce on the cloud infrastructure.

According to various embodiments, data leakage may be avoided, for example by keeping the group size at a constant size by introducing pseudo members as described above, by masking the key information as described above, and by adding a noise value to the group access key as described above to avoid common group users making used of approximate gcd methods to determine the keys.

According to various embodiments, security is provided, as no private key is revealed (but only checking is performed). Backward secrecy may be provided. Forward secrecy may be provided. According to various embodiments, flexible access control may be cloud applicable by providing protection against information leakage.

According to various embodiments, flexibility of members joining or leaving the group is provided. According to various embodiments, flexible access control may be flexible by avoid interaction from other users (other users than the user joining or leaving the group).

According to various embodiments, security is provided at only a light performance loss compared to an unsecured environment. In other words, according to various embodiments, flexible access control may be provided in a cost effective way by reduced computational complexity.

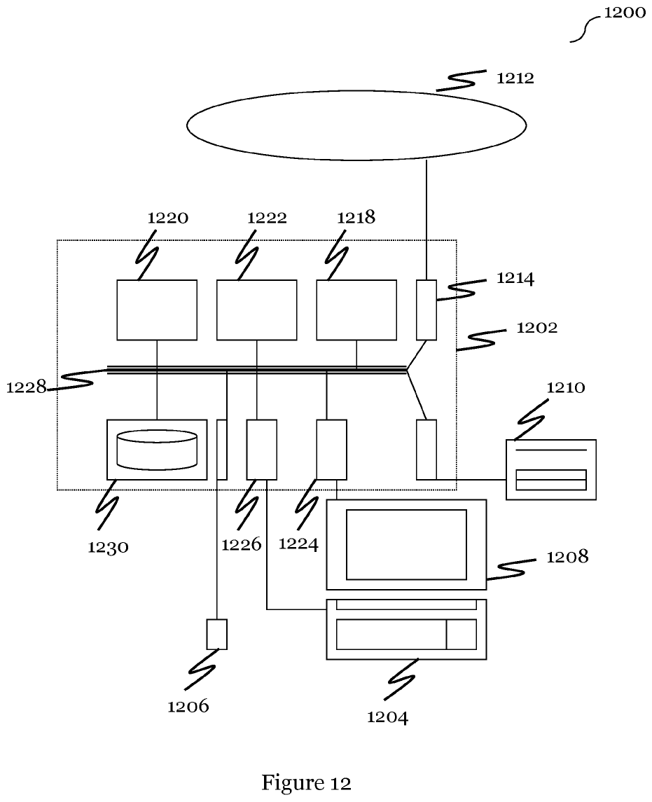

The access control device as described herein may be similar to a computer system 1200, schematically shown in FIG. 12. It may be implemented as software, such as computer programs being executed within the computer system 1200, and instructing the computer system 1200 to conduct the methods of the example embodiments. Similarly, portions of the computer system 1200 may be embodied in the access control device of the example embodiments.

The computer system 1200 may include a computer module 1202, input modules such as a keyboard 1204 and mouse 1206 and a plurality of output devices such as a display 1208, and printer 1210.

The computer module 1202 may be connected to a computer network 1212 via a suitable transceiver device 1214, to enable access to e.g. the Internet or other network systems such as Local Area Network (LAN) or Wide Area Network (WAN).

The computer module 1202 in the example may include a processor 1218, a Random Access Memory (RAM) 1220 and a Read Only Memory (ROM) 1222. The computer module 1202 may also include a number of Input/Output (I/O) interfaces, for example I/O interface 1224 to the display 1208, and I/O interface 1226 to the keyboard 1204. The components of the computer module 1202 may communicate via an interconnected bus 1228 and in a manner known to the person skilled in the relevant art.

The application program may be supplied to the user of the computer system 1200 encoded on a data storage medium such as a CD-ROM or flash memory carrier and may be read utilizing a corresponding data storage medium drive of a data storage device 1230. The application program may be read and controlled in its execution by the processor 1218. Intermediate storage of program data may be accomplished using RAM 1220.

While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A secure access control method for enabling secure access to a resource for a group of users without disclosing user private information, the method comprising:
receiving from a user a request for access to the resource;
determining a user key of the user in response to the request to access the resource, the user key comprising one of two or more prime numbers associated with the user;
determining a group access key related to the resource in response to information
associated with the resource, the group access key having been generated from multiplying together the two or more prime numbers associated with each user of the group, and wherein the group includes at least one actual member and at least one pseudo member;
determining whether the group access key is an integer multiple of the user key; and
granting the user access to the resource if it is determined that the group access key is an integer multiple of the user key.

2. The access control method of claim 1, wherein the information associated with the resource used for determining a group access key related to the resource comprises the sum of the group access key and a hash value.

3. The access control method of claim 2, further comprising:
authenticating the user.

4. The access control method of claim 3, wherein authenticating the user comprises:
determining a public key related to the user, wherein the public key is based on a product of a first private key of the user and a second private key of the user, wherein the first private key and the second private key each comprise a large prime number of the two or more large prime numbers associated with the user;
determining whether the user is in possession of the first private key; and
granting the user authentication if it is determined that the user is in possession of the first private key.

5. The access control method of claim 4, wherein determining whether the user is in possession of the first private key comprises:
providing the user with a residual of a square of a pre-determined number with respect to the public key;
receiving a number from the user in response to providing the user with the residual of the square of the pre-determined number with respect to the public key;
determining whether a residual of a square of the received number is identical to the residual of the square of the pre-determined number with respect to the public key; and
determining that the user is in possession of the first private key if it is determined that the residual of the square of the received number is identical to the residual of the square of the pre-determined number with respect to the public key.

6. (canceled)

7. The access control method of claim 1, further comprising:
removing a pseudo member from the group when an actual member is added to the group.

8. The access control method of claim 7, further comprising:
multiplying the group access key by a number equal to a user key of the user to be added to the group multiplied by an inverse of a user key of the pseudo member to be removed from the group when the actual member is added to the group.

9. The access control method of claim 1, further comprising:
adding a pseudo member to the group when an actual member is removed from to the group.

10. The access control method of claim 9, further comprising:
multiplying the group access key by a number equal to the inverse of a user key of the user to be removed from the group multiplied by a user key of the pseudo member to be added to the group when the actual member is removed from the group.

11. An access control device for securely managing access to a resource by a group of users, the access control device comprising:
a receiver configured to receive from a user a request for access to the resource;
an access circuit coupled to the receiver and configured to determine a user key of the user in response to the request to access the resource, the user key comprising one of two or more prime numbers associated with the user;
wherein the access is configured to determine a group access key related to the resource in response to information associated with the resource, the group access key having been generated from multiplying together the two or more prime numbers associated with each user of the group, and wherein the group includes at least one actual member and at least one pseudo member;
wherein the access circuit is configured to determine whether the group access key is an integer multiple of the user key; and
wherein the access circuit is configured to grant the user access to the resource if it is determined that the group access key is an integer multiple of the user key.

12. The access control device of claim 11, wherein the access circuit is configured to store the information associated with the resource used for determining a group access key related to the resource as the sum of the group access key and a hash value.

13. The access control device of claim 11, wherein the access circuit is configured to authenticate the user, wherein authenticating the user comprises:
determining a public key related to the user, wherein the public key is based on a product of a first private key of the user and a second private key of the use, wherein the first private key and the second private key each comprise a large prime number of the two or more large prime numbers associated with the user;
determining whether the user is in possession of the first private key; and
granting the user authentication if it is determined that the user is in possession of the first private key.

14. The access control device of claim 13, wherein determining whether the user is in possession of the first private key comprises:
providing the user with a residual of a square of a pre-determined number with respect to the public key;
receiving a number from the user in response to providing the user with the residual of the square of the pre-determined number with respect to the public key;
determining whether a residual of a square of the received number is identical to the residual of the square of the pre-determined number with respect to the public key; and
determining that the user is in possession of the first private key if it is determined that the residual of the square of the received number is identical to the residual of the square of the pre-determined number with respect to the public key.

15. (canceled)

16. The access control device of claim 11,
wherein the access circuit is configured to remove a pseudo member from the group is performed when an actual member is added to the group.

17. The access control device of claim 16,
wherein the access circuit is configured to multiply the group access key by a number equal to a user key of the user to be added to the group multiplied by an inverse of a user key of the pseudo member to be removed from the group when the actual member is added to the group.

18. The access control device of claim 11,
wherein the access circuit is configured to add a pseudo member to the group is performed when an actual member is removed from to the group.

19. The access control device of claim 18,
wherein the access circuit is configured to multiply the group access key by a number equal to the inverse of a user key of the user to be removed from the group multiplied by a user key of the pseudo member to be added to the group when the actual member is removed from the group.

20. A computer readable medium comprising instructions which, when executed by a processor, make the processor perform a secure access control method for securely accessing a resource by a user of a group without disclosing user private information, the secure access control method comprising:
receiving from a user a request for access to the resource;
determining a user key of the user in response to the request to access the resource, the user key comprising one of two or more large prime numbers associated with the user;
determining a group access key related to the resource in response to information associated with the resource, the group access key having been generated from multiplying together the two or more large prime numbers associated with each user of the group, the group including at least one actual member and at least one pseudo member;
determining whether the group access key is an integer multiple of the user key; and
granting the user access to the resource if it is determined that the group access key is an integer multiple of the user key.

21. The secure access control method of claim 1, wherein each of the two or more prime numbers associated with each user of the group comprises a large prime number.

22. The access control device of claim 11, wherein each of the two or more prime numbers associated with each user of the group comprises a large prime number.
